(19) United States
(12) Patent Application Publication
(10) Pub. No.: US 2012/0241530 A1
(43) Pub. Date: Sep. 27, 2012

(54) INTERACTIVE JOINTS FOR FIRE-FIGHTING WATER TURRET

(76) Inventor: Arthur E. Brown, Huntington Beach, CA (US)

(21) Appl. No.: 13/052,558

(22) Filed: Mar. 21, 2011

(51) Int. Cl. B05B 15/08

(52) U.S. Cl. 239/1; 239/587.1

(57) ABSTRACT

Disclosed are a turret or monitor apparatus and methods for directing the direction of a fluid stream, such as water or fire retardant foam, from a turret or monitor mounted in a fixed position, such as for example a vehicle, a platform or a building, where the fluid stream direction from the device is controlled through changes in the rotation of one or more conduit sections of the turret or monitor in multiple axes and the amount of rotational change in each conduit section is determined by detecting rotational units.

### FIELD OF INVENTION

This invention relates to devices such as a fire-fighting turret or monitor mounted in a fixed position, where the stream direction of a fluid such as water or fire retardant foam from the device is controlled through changes in direction of the device in multiple axes of motion.

### BACKGROUND

In firefighting and other applications, turrets and monitors are used to direct a stream of fluid. Often such turrets and monitors are mounted on buildings, trucks, truck ladders, and boats for better control and to allow closer proximity to more effectively perform. The present disclosure generally relates to apparatuses, systems and methods for controlling the direction of the flow of a fluid from a firefighting turret or monitor, or similar fluid-projecting device, which can be aimed on multiple axes in any direction by manipulating controls. It is desirable to make such turrets cover an area with a volume of water by appropriately moving the nozzle continuously or intermittently to aim the water stream in different directions. Some designs allow automatic oscillation of output in back and forth sweeping or other motion. In general, the positional variables of the monitor include the elevation and azimuth in which the nozzle is pointing or spraying. Thus terms like Left, Right, Up and Down are often used to label the positional turret controls and describe the motion that the turret nozzle travels to change the stream. The user may use various types of control systems or drive systems to change the nozzle position. These systems can be manual, use gears, hydraulics, or electronics. However, each of these systems work by raising and lowering the elevation of the monitor's nozzle along a horizontal axis, and rotating about its azimuth to change the position of the nozzle along a vertical axis. In addition, each of the axes or joints could be held against unintended movement by a mechanical device such as a friction lock or a pin in a hole. To gain the torque necessary to control the joints and to supply the static friction required to hold the nozzle in place when not being moved in one of the axes, a combination of gears including a worm gear was generally used.

As the state of the art has evolved from handheld hoses and nozzles to the manually operated turrets, and on to the remotely controlled and automatic monitors discussed above, there has been a tendency to add onto current methods without going back to the primary function to be served and creating a product from the ground up. Thus the rotational axes necessary to create independent left-right and up-down actions in a turret were maintained. Automating merely meant adding electrical, mechanical or hydraulic actuators to the joints and swivels that were used in the mechanically controlled units. U.S. Pat. No. 2,698,664 granted to Freeman and U.S. Pat. No. 2,729,295 granted to Edwards are examples of such systems.

Several general models of monitors have been devised to create the ability to sweep through the necessary range. One of these is a re-converging stream in which the water generally passes through a pipe that swivels to create the left-right rotation and coverage, then splits roughly equally and directs the water through separate symmetric pipes into flows which are perpendicular to the first swivel. This allows for a second set of swivels to provide the up-down coverage. Then the water is re-converged into a single stream and sent through a nozzle as desired. U.S. Pat. No. 2,834,419 issued to Becker discloses one such design. This model requires several complex cast components. Splitting the water into two pipes, forcing it through a quick series of sharp bends, then recombining the two streams which are running in almost opposite directions creates turbulence, back pressure and pressure losses that are detrimental to the water flow.

Another model can be thought of as a series of bent tubes. In this traditional configuration the water stream is forced through a total of 405 degrees of bend, with one bend being a 180 degree bend causing the stream to flow twice as far and twice as fast on the outside of the bend as the water on the inside of the bend. This geometry also creates turbulence and pressure drops that are adverse to the final stream pattern and shortening the distance water is expelled. This is undesirable in that it requires more powerful pumps to overcome the inefficiencies of the resultant waterway or forces fire fighters to be closer to the fire to effectively place the stream.

A third model is a bent tube design created by using castings. This allows for a tighter geometry but exaggerates the turbulence caused by stream flow speed differentials. In order to combat these problems, this design is forced to increase the cross-sectional area of the joint areas, which further increases turbulence and forces acting on the joints. Even internal flow straightening vanes cast into the waterways to combat these deficiencies have the adverse effect of causing additional surface drag. One example is U.S. Pat. No. 4,607,702 issued to Miller.

When these designs were automated to allow for remote operator control through switches or a joystick, or to allow for automatic operation in a preset manner without input from an operator, gearing and actuators such as electric and hydraulic motors were added on top of existing designs.

Fully incorporated herein by reference, U.S. Pat. No. 6,655,613 issued to Brown discloses a turret or monitor for discharging fluids with a design incorporating multiple conduit sections that rotate in a manner that allows for simple and accurate nozzle control while minimizing turbulence and fluid swirl. Brown discloses a monitor system with three conduit sections, the interface between each of the conduit sections forms a joint. The axes of rotation for each joint at an acute angle to the axis of rotation of the other joint. The rotation of one conduit section about a joint defines the relationships between the positions and actions of the joints with respect to each other and the fluid stream direction out of the system. In Brown, the conduit sections rotate using a drive mechanism to controlling the motion of rotating.

The invention of the 613' patent provides an efficient waterway for controlling the movement of a mounted monitor by rotation of the conduit sections at the two joints. Each of the two joints having a rotation axis acute to one another, providing the discharging of a fluid in any direction within a hemisphere. To move the direction of the fluid discharge from the monitor in a horizontal plane (i.e. Left and Right), referencing a vertical axis for the base conduit section, the rotation, with respect to each other, of the base and midsection of the conduit making up the first joint is a function of swiveling the first joint alone. Such motions of the first joint do not affect the elevation of the output and only rotate the monitor on a horizontal plane. Due to the relationship of each joint's rotational axes, a rotation of the midsection and exit section of the conduit, making up the second joint, not only affects the elevation of the output but also contributes a component of slight change in position in the horizontal direction as well. This dual effect on the vertical plane (up and down) and the horizontal plane (left and right) position of the nozzle is not typical of fire-fighting turret designs and in most cases is not desirable. It can be referred to as either a) swiveling the elevation axis also affects the radial direction or b) changing only the elevation of the output requires swiveling both the elevation and rotation axes. As described in the 613' patent, the amount of compensating swiveling of the rotation axis is not linearly related to the change in elevation.

613' describes the relationships and explains the relationship of conduit section motions at each joint required to achieve a result consistent with the operation of the traditional control directions of LEFT, RIGHT, UP, and DOWN common to the industry. The 613' patent refers to several methods of controlling the movement of conduit sections at each joint to produce the desired aim of the exit nozzle, including a microprocessor controlled means, and describes the mathematical relationships to be performed by a control system. In each case a knowledge of the relative elevation direction of the monitor's exit section, E, and its change, ΔE, (or more accurately, the change in rotation of the conduit sections of the second joint) is required to be captured as data, and the necessary corresponding rotational actions of the conduit sections of the lower joint is required to compensate for undesired horizontal component of movement. This change is computed as a function of E or ΔE.

Table I from 613', shown below, shows the relationship between the planar angles of the joint comprising the base conduit section and the lower midsection and the joint comprising the upper midsection and the conduit exit section as the conduit sections are rotated to provide a change in the elevation of the nozzle attached to the exit section. Table I shows uniform changes in nozzle elevation represented as five degrees increments, along with the required change of the elevation in the upper joint 22 and the rotation of conduit section at the lower joint 16. It is seen that the planar angle of joints do not uniformly change to accomplish a consistent change of 5° in elevation as the conduit sections are rotated about their respective joints.

TABLE I

| Elevation (degrees) | Joint 22 (degrees) | Joint 16 (degrees) |
|---|---|---|
| 0 | 0 | 0 |
| 5 | 34 | 24 |
| 10 | 49 | 33 |
| 15 | 61 | 40 |
| 20 | 72 | 46 |
| 25 | 81 | 50 |
| 30 | 90 | 55 |
| 35 | 98 | 59 |
| 40 | 107 | 62 |
| 45 | 114 | 66 |
| 50 | 122 | 69 |
| 55 | 130 | 72 |
| 60 | 137 | 74 |
| 65 | 144 | 77 |
| 70 | 152 | 80 |
| 75 | 159 | 82 |
| 80 | 166 | 85 |
| 85 | 173 | 87 |
| 90 | 180 | 90 |

The monitor design disclosed in the 613' patents is limited in that it requires sophisticated drive mechanisms to calculate the relationship between joints and to properly rotate the conduit sections to achieve the desired elevation change in the exit section. These drive mechanisms can be mechanical, hydraulic or electronic, but all must have a means of determining the position of one conduit section with respect to the others. This requirement requires a means of determining the rotational location of the conduit section and calculating the elevation value as a function of positions of each joints planar angle. The calculating means add significant costs in designing, engineering and manufacturing of the monitor. Additionally, these mechanisms are more prone to failure and require preventive maintenance to avoid failure.

Therefore a need exists for a solution to the aforementioned problems. The present teachings provide such a system. This invention relates to methods of controlling the movement of such conduit section without the use of a microcontroller or other digital or analog logic devices.

### SUMMARY OF THE INVENTION

In view of the foregoing background, the present invention overcomes the limitations of the prior art by providing for a turret or monitor apparatus and methods for directing the direction of a fluid stream, such as water or fire retardant foam, from a turret or monitor mounted in a fixed position, such as for example a vehicle, a platform or a building, where the fluid stream direction from the device is controlled through changes in the rotation of one or more conduit sections of the turret or monitor in multiple axes. The amount of each respective rotation is determined by setting values for rotational units and rotating each conduit section at rates corresponding to the desired position of flow output.

In one aspect of the current invention, a monitor is disclosed with a means for increasing and decreasing the elevation of fluid output from a monitor in a linear plane by rotating the conduit sections that make up the respective joints in the monitor without the need for measuring, determining or calculating the angular position of the respective conduit section joints between its actual current position and a base or home position. For more precise linear movements finer angular divisions are necessary and for more course movements, fewer angular divisions are required.

One aspect of the inventive method is disclosed that provides for dividing the range of conduit section rotational joint motions into equal rotational units of a unit size and quantity appropriate to allow control of the desired level of precision of motion of the monitor. The value of the rotational units of the rotation joint varies from the value of the rotational units of the elevation joint. Further, the value of rotation units of the elevation joint will be different at each elevation and a function of the amount of rotational change that has occurred.

In another aspect of the invention, the rotational units of each conduit section may be detected, determined or read. The determination of rotational units may be done mechanically by such means as counting the teeth on a gear, or by counting holes or protuberances evenly spaced on an arc about the circumference of a conduit section. Other means for counting can also be employed, for example optical means such as spaced LED or fiber optic light sources or reflective materials. Additionally, Hall effect means may also be employed, such as deposited magnetic material or similar material embedded or protruding from the surface of the conduit close enough together that moving from one to the adjacent unit allows for a determination of the change in rotation. Preferably the incremental units are as small as or smaller than the smallest change in rotation that can be desired in practice; they may be read optically or electronically.

In another aspect of the current invention, methods are disclosed for effecting independent control in the perceived coordinate system of UP, DOWN, LEFT, and RIGHT, in a turret or monitor with a plurality of conduit sections and joints, without the need of independent conduit section position sensing, computation, or computerized control.

In another aspect of the current invention, elevation changes in the monitor's exit nozzle are a function of rotational change in each conduit section. This is distinct from change created in the design disclosed in 613' in that the concept of directional compensation in the vertical plane is a function of the rotational change in the conduit section. That is to say, rather than rotating the conduit section of the rotation joint about a vertical axis in an effort to compensate for horizontal changes of the elevation joint created by rotation of the conduit sections of the elevation joint, it is proposed to create a defined arc of rotation as the unit of measure, and then define or set the amount of rotational change in the elevation joint from the present elevation position. The amount of defined arc will be an amount required to return conduit section to the previous rotational position regardless of the resulting change in elevation. This unit of elevation joint rotation will not be identical at every elevation position of the elevation joint, but rather will be determined according to the following equation:

The elevation joint conduit section rotation correspond to a rotation of the conduit section of the rotation joint, where T is the angle rotated by elevation joint; M is the dihedral angle of the planes of the elevation and rotation joint; and B is the angle rotated by the rotation joint in the formula:

$$T = arccos ( \frac{1 - {cos}^{2} ( M ) \times {tan}^{2} ( B )}{1 + {cos}^{2} ( M ) \times {tan}^{2} ( B )} )$$

The disclosed methods of relating units of conduit rotation to the joints allows for simplified implementations of turret and monitor controls, where the commonly expected motions can be achieved with standard type controls and without the need for computations, calculations or the determination of relative positions of joints or motion of the conduit sections. Such a turret or monitor systems can be started without any need for data or feedback of joint positions or motions and by means of the described methods can produce standard motions from a simple and standard control.

Additionally, it is possible to use a method, whether mechanical, electrical, water powered or other or combination thereof, whereby a moving action is applied to both swiveling joints so that each is caused to move one unit in the desired direction. This method of combined and simultaneous motions of the conduit sections of each joint when a change in elevation is required will maintain an effectively constant rotational angle while changing the elevation as desired. Using simple logic, whether mechanical, electrical or digital, it is possible to use the same approach in combination with additional mechanisms to produce only rotational motion or combined motion in both the rotation and elevation axes.

The current application discloses methods of relating units of rotation to the rotational requirements for each joint to allow for simplified implementation of controls where the commonly expected motions of a turret can be achieved with standard type controls and there is no need for complex computations, calculations or the determination of relative positions or motion of conduit sections making of the joints of a monitor. The system can start cold without any knowledge or feedback of joint positions or motions and internally by means of the described methods produce standard motions from a simple and standard control.

This and other objects, features and advantages are in accordance with the present invention.

### BRIEF DESCRIPTION OF THE DRAWINGS

Embodiments of the present disclosure will be more readily understood by reference to the following figures, in which like reference numbers and designations indicate like elements.

FIG. 1 is a profile view of one embodiment of the invention showing the relative angles of the two joints according to the present teachings.

FIG. 2 is a front view schematic representation of the output of a monitor representing a plane in which the output would be confined.

FIG. 3 is a schematic representation of an embodiment with a joystick control wirelessly connected to a truck mounted monitor with motors for rotating each joint independently according to the present teachings.

FIG. 4—A representation of a method of control with a mechanically actuated electric switch which allows only one of the joints to rotate “one unit” before allowing the second joint to rotate “one unit” in response to an operator's command for a traditional change in elevation.

FIG. 5: Represents a mechanical means of allowing the conduit sections of each joint to be rotated by an operators command where the relative number of units rotated by each is maintained within an acceptable range by a mechanical tally counter according to the present invention.

FIG. 6: Represents a mechanical system of driving palls which simultaneously drive each joint in the correct direction a single unit of rotation.

### DETAILED DESCRIPTION OF THE PREFERRED EMBODIMENTS

The present invention provides for a turret or monitor apparatus and methods for directing the stream of a fluid, such as water or fire retardant foam, from a monitor mounted in a fixed position, such as for example a vehicle, a platform or a building, where the fluid stream direction from the device is controlled through changes in the rotation of one or more conduit sections of the monitor in multiple axes and the amount of rotational change in each conduit section is determined by detecting rotational units.

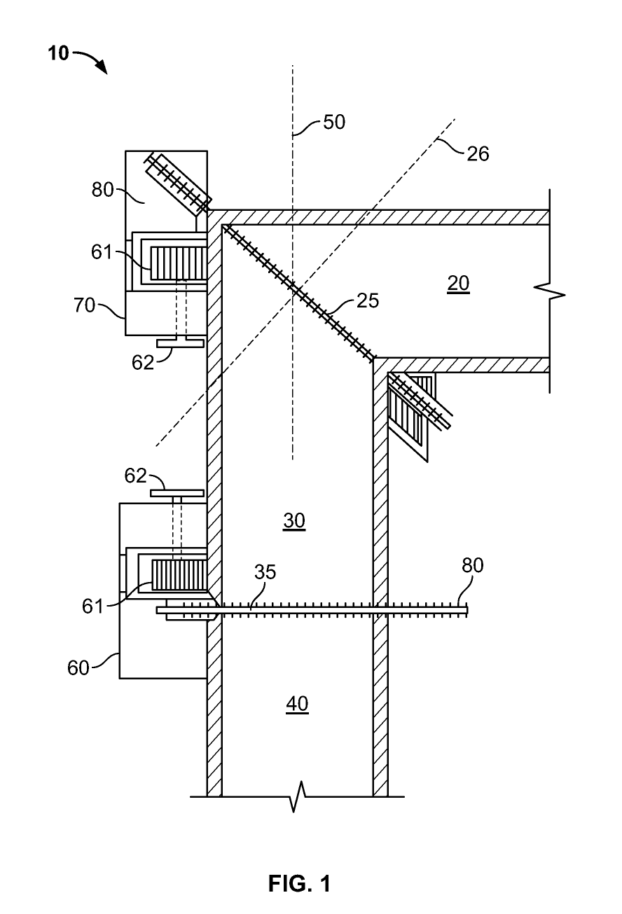

The present invention will now be described more fully with reference to the accompanying drawings, which shows the preferred embodiments of the invention. This invention may, however, be embodied in many different forms and should not be construed as limited to the illustrated embodiments disclosed. Rather, these embodiments are provided so that this disclosure will be thorough and complete, and will fully convey the scope of the invention to those skilled in the art. Like numbers refer to like elements throughout. The monitor apparatus and methods will now be described in detail, with reference made to FIGS. 1-6.

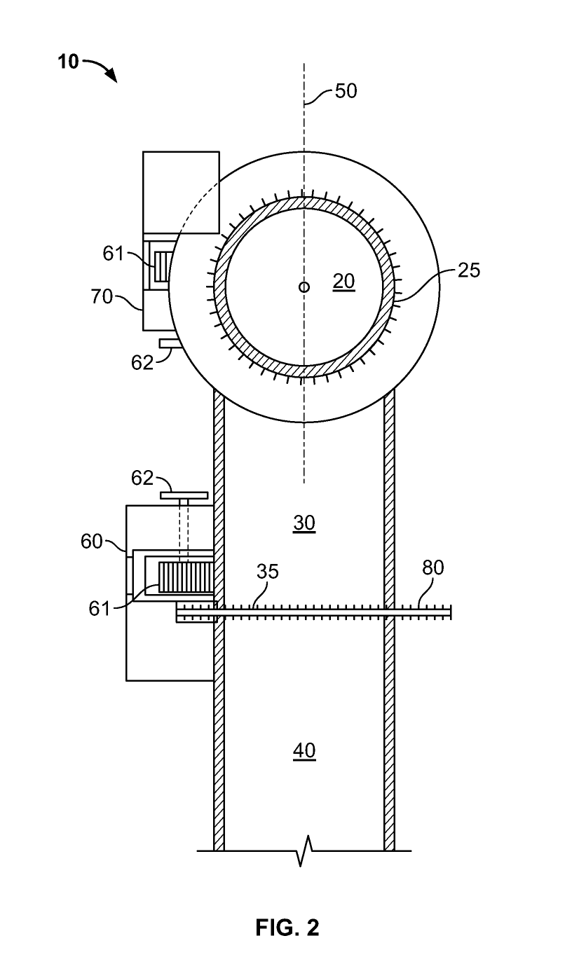

Referring now to the drawings, where the showings are for purposes of illustrating the preferred embodiments of the invention-only and not for purposes of limiting the same. Referring to FIGS. 1 and 2, FIG. 1 provides a side profile view of a representation of a turret or fire monitor 10, and FIG. 2 provide a front profile of the same turret or monitor 10 without regard to the fact that a cylinder cut at an angle produces a elliptical cross section and will not mate with another elliptical cross section except at 0 and 180 degrees. The monitor 10 has an exit conduit section 20, a mid conduit section 30, and a base conduit section 40. It will be appreciated by one skilled in the art that there can be any number of sections allowing for a complete range of motion for the monitor. The number of sections need not be limited to three. The interface between the base section 40 and the midsection 30 form a first joint 35. The base section 40 and midsection 30 independently rotate at the first joint 35 about an axis 50 and allows motion of the monitor in 360 degrees about the axis 50. The interface between the midsection 30 and the exit section 20 form a second joint 25, which is positioned substantially at a forty five degree angle or any angle less than ninety degrees to the first joint 35. The exit section 20 and the midsection 30 independently rotate at the second joint 25 about a second axis 26 that is perpendicular to the plane of the second joint 25.

The rotation of the mid and base conduit sections 30, 40 at the first joint 35 is achieved by a drive motor 60 and at the second joint 25 by a drive motor 70. A single motor with linking mechanisms may be used for driving the conduit sections, but in the preferred embodiment the drive motors 60, 70 are direct drive pinion gears 61 in association with ring gears cast or welded to each respective conduit section (not shown). The motors 60, 70 have relatively small drive gears 61 that engage the much larger gear ring gear (not shown) of the rotating joints 25, 35. Because of this size disparity, it is possible in the device of the invention to use a direct drive instead of the more cumbersome worm gear drive typical of the prior art designs. This in turn makes it practical to rotate the joints 25, 35 by hand, e.g. in case of a motor failure, through a hand wheel 62. It is known that a number of drive mechanism types could be implemented to achieve the rotation of the conduit sections, for example a Geneva drive.

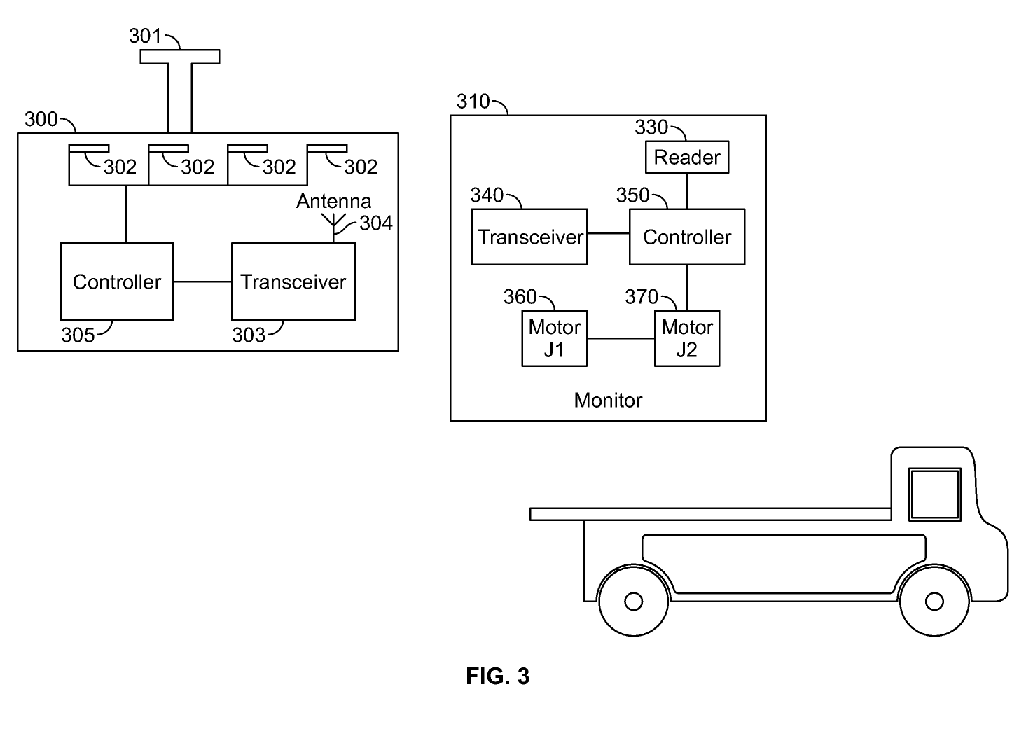

Now with reference to FIG. 3, in the preferred embodiment, a motion controller 300 such as a joystick is used as the human interface for controlling the motion and position of the monitor 310. The motion controller could also employ a ring button that can be depress in 360 degrees of direction. The motion controller 300 has a position control stick 301, a microprocessor 305, directional switches 302, and a transceiver 303 with an antenna 304. The position control stick 301 is a well know type of joystick and causes the monitor to move to a position corresponding to the position of the position control stick 301. The position control stick 301 has no center or neutral position to which an unattended stick will return. A position control stick 301 is moved by the user to the position intended for the monitor 310 and remains in that position so that it is possible to infer or know the position of the monitor 310 by looking at the position control stick.

The position control stick 301 can be ‘bang/bang’ or proportional type. A bang/bang stick has a set of switches 302 (typically 4, but more may be included) that are activated when the stick 301 is moved from the neutral position. If the position control stick 301 is pointed toward a switch 302 located at a particular North, South, East, West position, that switch is activated in a simple on/off function. Motion control sticks cause the monitor to move whenever the joystick is moved from its center or neutral position. When the joystick is released it will return to the neutral position. With a motion control stick it is not possible to infer or know the position of the monitor from the position of the joystick. Preferably, the position control stick 301 is a proportional stick, which causes the speed or response in the desired direction(s) to be proportional to the input of the position control stick 301, such as how far from center the stick is moved or how much force is applied to the stick and whether or not that force results in any motion of the stick from center.

The motion controller 300 can be 4-way or an 8-way direction controller. With a 4-way controller it is possible activate switches 302 in only one of 4 independent directions at a time. These correspond to Up, Down, Left and Right motions of the monitor 310. With a 4-way stick it is not possible to cause simultaneous motion in both the Up/Down direction and the Left/Right direction simultaneously. The preferred embodiment incorporates an 8-way stick. With an 8-way stick, switches 302 are located at evenly spaced intervals between North, South, East, West and provide finer resolution of movement of the monitor 310. It is additionally possible to request simultaneous motions in these directions such as Up/Left, Down/Left, Up/Right, Down/Right.

Electrical signals are generated by the switches 302 when the particular switch is closed by the position control stick 301. These signals are communicated to a microcontroller 305. The microcontroller can perform calculations to provide more precise control of the rotation of the conduit sections at the joints. These calculations are discussed further below.

The motion controller 300 can be directly wired to the monitor 310 or wireless depending on the preferred application. For example, if a firefighter desires to control the direction of the monitor mounted on a fire truck while in the cab of a fire truck, the monitor may be directly wired communicate via the databus network of the fire truck. In applications where the fire fighter is away from the fire truck and cannot get close to the monitor because of heat from the fire, the fire fighter would prefer wireless control of the monitor. In the wireless embodiment, the motion controller 300 is in communication with the monitor 310 via two-way wireless radio frequency transmissions. A transceiver 303 is associated with the micro-controller 305 receiving directional instruction corresponding to the position control stick 301 location for transmission to the transceiver 340 of the monitor 310. A monitor controller 350 is associated with a second transceiver, the monitor motors 360, 370, and a rotational unit reader 330. The directional message is transmitted from the motion controller transceiver 303 to the monitor transceiver 340, where it is received by the monitor microcontroller 350. The monitor Microcontroller 350 will query the rotational unit reader 330 for the value of the rotational units of each conduit section and provides motion instructions to the joint motors 360, 370. The rotation unit reader 330 units of rotation associated with each conduit section and corresponding to the positions of each conduit section of the monitor 310 and electronically communicates the rotational unit values of each joint to the microcontroller 350.

The rotation of each conduit section is monitored by a rotational unit reader, in FIG. 1, 80, and in FIG. 3, 330. The rotational unit reader 80, 330 reads rotational units indicative of the amount of rotation of each conduit section by detecting rotational unit indicators on the each conduit section 20, 30, 40 at the joints 25, 35. The nature of the rotational unit reader will depend on the nature of the unit indicator 80 chosen for the implementation. In the preferred embodiment, the unit indicator is a raised protrusion 80 on the surface of the conduit section or on an extender of the ring gear that drive the respective conduit section. Various indicators are contemplated and can be indentations, grooves or ridges instead of protrusions. The indicators could be a polished reflective surfaces, embedded LED or fiber optic light sources. Alternatively, light can be transmitted from the rotational unit reader and reflected back to light sensor in the reader, many such systems are well known. The rotational unit reader could also be a Hall Effect device where the unit indicator 80 is a magnetic spot on the conduit section or ring gear and the rotational unit reader is a coil with electronic circuitry able to detect changes in current as the unit indicator moves past the coil position.

With respect to the rotational joint 35, in the preferred embodiment, the unit indicators 80 are raised protrusions located on the base conduit section 40 and mid conduit section 30 or their associated rotation ring gear (not shown). The value of each rotational unit for conduit sections 30, 40 making up the first joint 35 will not correspond on a equal basis to the value of the rotational unit indicators for the conduit sections 20, 30 making up the second joint 25.

The movement of conduit sections 20, 30, 40 in order to obtain the desired directional aim of the monitor 10 can be complex. For example, because the exit section 20 rotates at the second joint 25 about the axis 26, the direction of a fluid flow from the monitor will be conical as the exit section 20 rotates and any rotational movement will be composed of both a horizontal and a vertical movement component. If it is desirable for the path of fluid to flow in a purely vertical up and down plane, as the exit section 20 rotates the midsection 30 must also rotate in a direction opposite to compensate for the horizontal component of the conical motion in the exit section 20. The rate of rotation of each conduit section is note equal, so it is also necessary to compensate for the timing variance. When an fluid flow direction is desired that requires rotation in the direction opposite to the inherent motion caused by the conical rotation of the elevation joint, by varying the value of the rotational units at places along the circumference of each joint it is possible to pause the elevation component of motion in the exit section 20 until appropriate value of rotation units in the horizontal rotation of the first joint 35 have been counted for every elevation unit.

Mechanical and Electrical Methods

Two methods are provided for controlling the motion of the conduit sections about the axis of rotation for each joint.

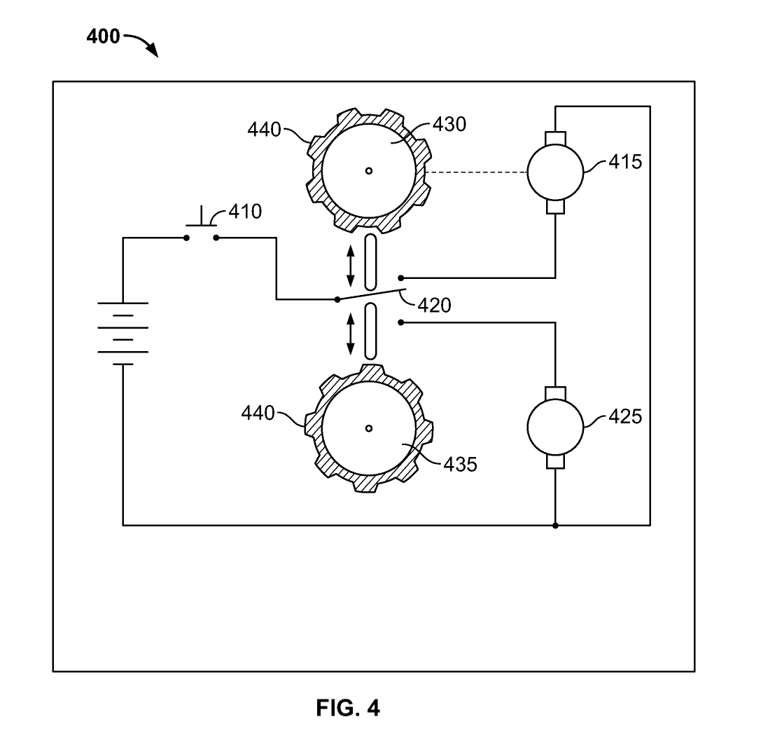

The first method is the Shuttle Method: This method is represented in FIG. 4 and provides a one-to-one ratio of rotational change for the conduit sections at each joint, where a motion of one rotational unit in conduit section of the first joint immediately initiates a corresponding motion of one rotational unit in the conduit sections of the second joint. The rotational motion of the conduit sections in the second joint must occur before motion in the conduit section of first joint is again possible. This process is repeated as long as a change in one direction (UP or DOWN) of elevation is required.

FIG. 4 depicts the logic described and is represented as a simple circuit 400 including a first switch 401 that controls power to a first motor driving movement of conduit sections making up a first joint 430, and a second switch 420 that controls power to a second motor 425 driving movement of conduit sections making up a second joint 435. Protrusions 440 on the surface of the conduit sections represent rotation units that determine the amount of rotation a conduit sections of the first joint 430 must move before any movement is possible in conduit sections of the second joint 435. The wider the protrusion, the greater the unit indicator value and thus distance of rotation. For example, when a change in elevation is requested, the first switch 410 will close allowing power to flow through the second switch 420, whichever motor that is enabled 414 or 425 by the second switch 420 will drive until the respective protrusion 440 or rotation unit Indicator toggles the second switch 420 to drive the second motor. This alternating driving continues while the first switch 410 remains closed.

The design of this system allows motion, (when elevation motion is called for) in only one axis at a time and the ability to make the next move by either axis is controlled by the last motion of the other joint. This keeps the motion in real-time synchronization by alternating and interlinking motion between the two joints. It will be appreciated by one skilled in the art that rotational motion requires only action of the rotation at the joints and is assumed to be well understood and not considered in this section.

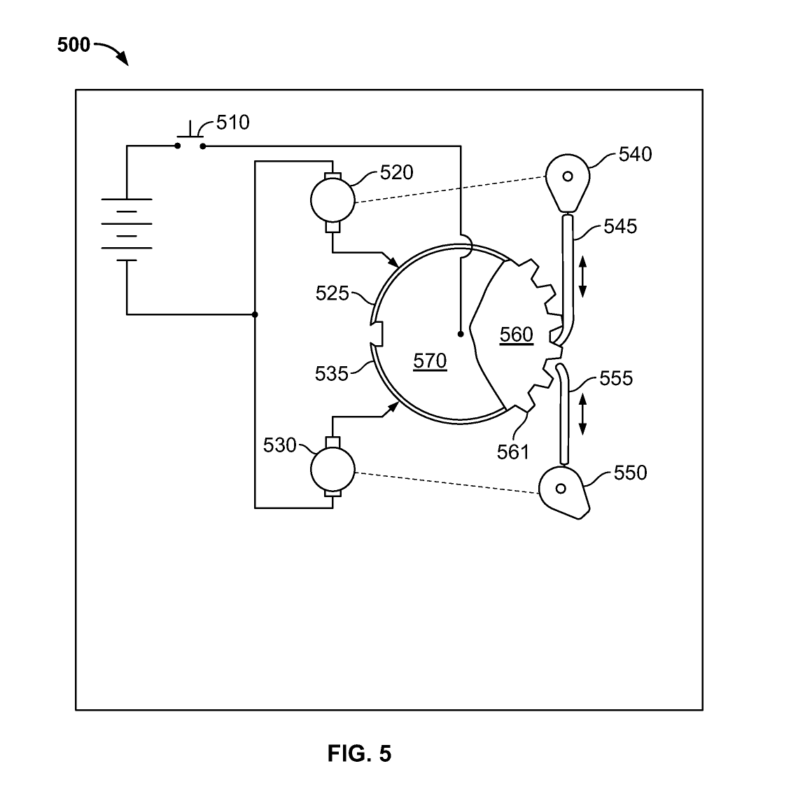

FIG. 5 discloses another method referred to as the Integrating Method. The Integrating Method that allows simultaneous driving of the conduit sections about each of the joints and tracks any differences in the number of rotational units each conduit section has turned; the method continues to turn the conduit sections of the lagging joint until it has turned through the same number of rotational units as the leading joint. Either joint may be the lagging or leading joint. It may be desirable to limit the number of rotational units or amount of rotation that one joint can be out of sync with the other joint. This can be achieved by stopping the rotation of conduit section of the leading joint until the lagging joint catches up, either to even or lagging by an acceptable amount.

The Integrating Method is shown below as a simple electrical circuit 500, but could be done as well with a mechanical linkage that alternately engages and disengages each joint. The distance each conduit section is moved in each cycle corresponds to the value of one rotational unit. When a change in elevation is desired, the switch 510 is closed allowing current to flow to a first motor 520 controlling the rotation of the conduit sections making up the elevation joint, and a second motor 530 controlling the rotation of conduit sections making up the horizontal joint. The first motor 520 is driven when the circuit is closed by a sliding contact 525 and second motor is driven the circuit is closed by a second sliding contact 530. The top motor 520 drives cam 540 and the bottom motor 530 drive cam 550. The cams 540, 550 each push respectively rods 545, 555 to rotate a rotor 560 by pushing on the cogs 561 of the rotor 560. As the rotor 560 rotates incrementally driven by the cams 540 and 550 the sliding contact 525 will be disconnected from a common connection 570 which is permanently connected to the switch 510 whenever the top motor 520 has over-driven the bottom motor 530 by the number of units required to disconnect the sliding contact 525. The sliding contact 535 behaves similarly when the bottom motor 530 has over-driven the top motor 520. The design of the size and relative positions of the sliding contacts 525, 535 and the common contact 570 creates a definable number of units by which the cams 540 and 550 can be out of sync, yet both the top motor 520 and bottom motor 530 will be driven. When the synchronization has exceeded the defined number of units, either the sliding contact 525 or the sliding contact 535 will be opened allowing the conduit sections of the appropriate joint to drive back into acceptable synchronization. The bottom motor 530 will drive until the respective the rotor 560 toggles the sliding contact 525 to drive the top motor 520. This alternating driving continues while the sliding contact remains closed. It should be noted that FIG. 5 depicts the logic described and is only one method implementation. A simple implementation using electronics can be used as well. The concept is to allow for dual drive within a prescribed number of unbalanced unit counts.

Using simple logic, it is possible to use the same approach in combination with additional mechanisms to produce only rotational motion or combined motion in both the rotation and elevation axes. Additionally, this logic allow a single motor to control both required motions of each conduit section of the joints.

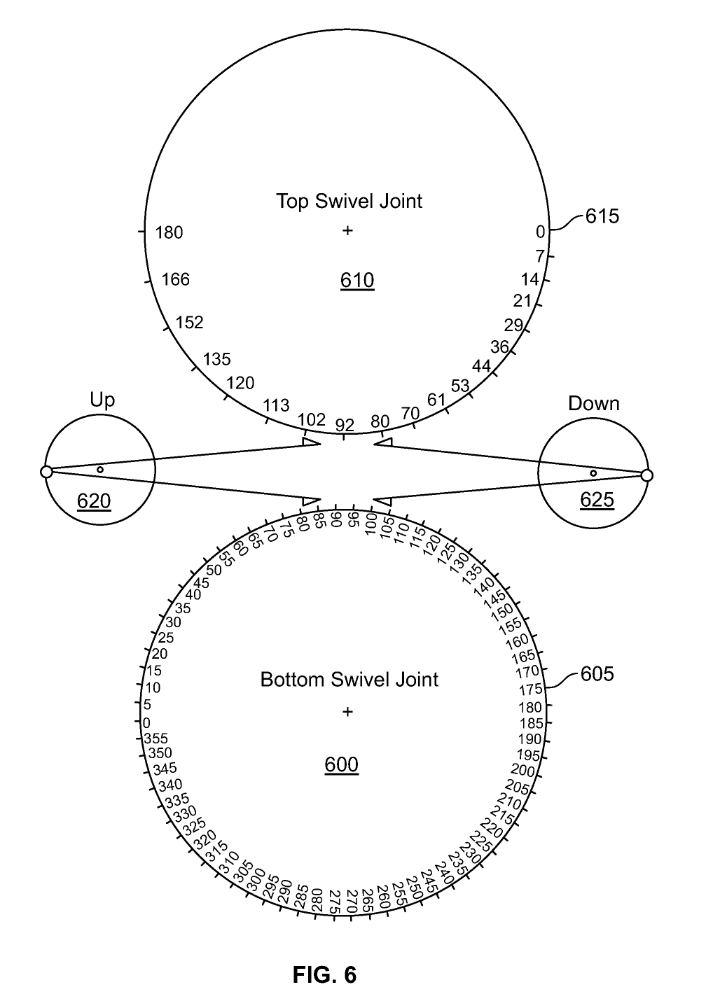

FIG. 6 diagrams the logic of such a method. The bottom joint 600 depicts equally spaced rotational units 605 of a conduit section covering the entire 360° of movement. In the bottom joint 600, the value of the rotational units is 5°, but could be any measure. The top joint 610 depicts units of rotation 615 with values calculated so as to compensate for undesired horizontal movement components of rotational caused by one unit of rotation of the bottom joint 600. The units shown are calculated for a monitor where the joints are angled at 45°. It should be noted that only 180° of rotation of the top joint 610 is necessary for the aim of the exit section to go from down to up.

A similar logic is represented with two mechanisms, an UP mechanism 620 and a DOWN mechanism 625. The logic represents a method of simultaneously advancing the top joint 610 and the bottom joints 600 to effect the desired independent change in elevation. Rotating the UP mechanism 620 causes the two pawls to move right beyond the vertical centerline of the system then return to the left while engaging a tooth on each incremental distance of the joint swivel, thereby advancing each swivel one unit of rotation. Action of the DOWN mechanism is similar. It is not merely the mechanism of motion that is important, but rather the relationship of required conduit section motions, either simultaneous or individually. It is essentially synchronous movement that has been defined by units of motion that is covered. These units of motion are not uniform for the top swivel, but are based on the monitor angle and the elevation angle.

With the unit indicators on each conduit section making up the rotating joints it is now possible without computation or calculation or even knowing either the elevation or rotation angles or joint positions to effect independent UP/DOWN as well as LEFT/RIGHT motions with a simple control. Left and Right motions require driving only the lower rotation joint. Up and Down motions require rotating both the elevation and the rotation joint (in the appropriate directions) a pre-defined amount: Each joint is driven an equal number of units, or marks, or bumps as the elevation is changed as desired.

For further reference regarding enabling systems, the following references are incorporated by reference in their entirety, as if disclosed herein in full: U.S. Pat. No. 6,655,613; and U.S. Pat. No. 7,137,578.

The foregoing description illustrates exemplary implementations, and novel features, of aspects of an apparatus and method for a turret or monitor for directing the direction of a fluid stream, such as water or fire retardant foam, from a turret or monitor mounted in a fixed position, such as for example a vehicle, a platform or a building, where the fluid stream direction from the device is controlled through changes in the rotation of one or more conduit sections of the turret or monitor in multiple axes. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

1. A method of controlling the direction of fluid exiting a conduit, the conduit capable of movement for discharging a fluid in any direction and consisting of a plurality of sections where adjoining conduit sections form and swivel about a joint and each such joint has an axis of rotation perpendicular to such joint and acute to the axis of rotation of an adjacent conduit joint, the method comprising the steps of:
a) dividing the range of rotation movement of at least two joints into angle units, the angle unit values of each joint being a different rotational distance;
b) rotating a first joint in a rotational plane a distance substantially equal to one angle unit having a first rotational distance;
c) detecting the incremental change of the first joint as it rotates in a rotational plane by monitoring the angle unit having a first rotational distance;
d) rotating a second joint in a second rotational plain a distance substantially equal to a second angle unit having a second rotational distance;
e) repeating the steps of a, b, c, and d until the flow of fluid from the conduit is at a desired elevation.

2. A conduit for directing of flow/output of a fluid, the conduit capable of discharging a fluid in any direction, the conduit consisting of:
a) a plurality of conduit sections where adjoining conduit sections form and swivel about a conduit joint, the plurality of conduit joints each having an axis of rotation acute to the axis of rotation of an adjacent conduit joints, the range of rotation movement of said plurality of joints is divided into rotational angle units about the circumference of the axis of rotation, the rotational angle unit values of each joint being a different rotational distance;
c) a means for rotating at least one of said plurality of joints in a rotational plane, the rotational distance substantially equal to one angle unit having a first rotational distance;
d) a means for detecting the incremental change of the one of said plurality of joints as it rotates in a rotational plane by monitoring the angle unit having a first rotational distance;
e) a means for rotating a second of said plurality of joints in a second rotational plane a distance substantially equal to a second angle unit having a second rotational distance.

3. The conduit of claim 2, wherein the means for rotating said at least one of said plurality of joints in a rotation plane is a drive gear.

4. The conduit of claim 2, wherein when the elevation joint conduit section rotation correspond to a rotation of the conduit section of the rotation joint in accordance with the following formula:
$$T = arccos ( \frac{1 - {cos}^{2} ( M ) \times {tan}^{2} ( B )}{1 + {cos}^{2} ( M ) \times {tan}^{2} ( B )} )$$
where T is the angle rotated by elevation joint; M is the dihedral angle of the planes of the elevation and rotation joint; and B is the angle rotated by the rotation joint.

5. The conduit of claim 2, wherein the means for rotating the plurality of conduit sections is in wireless communication with a controller.
